(19) United States
(12) Patent Application Publication
(10) Pub. No.: US 2009/0196306 A1
(43) Pub. Date: Aug. 6, 2009

(54) CONTENTION ACCESS TO A COMMUNICATION MEDIUM IN A COMMUNICATIONS NETWORK

(75) Inventors: Neal J. King, Munich (DE); Vladimir Oksman, Morganville, NJ (US); Charles Bry, Unterhaching (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: INFINEON TECHNOLOGIES AG, Neubiberg (DE)

(21) Appl. No.: 12/360,688

(22) Filed: Jan. 27, 2009

Related U.S. Application Data
(60) Provisional application No. 61/024,999, filed on Jan. 31, 2008.
(60) Provisional application No. 61/027,713, filed on Feb. 11, 2008.

(51) Int. Cl. H04L 29/08

(52) U.S. Cl. 370/462

(57) ABSTRACT

A method of providing contention access to a communication medium in a communications network includes transmitting priority information with each of a plurality of network nodes prior to a shared-contention transmission opportunity. The priority information for each node indicates a priority level of a frame that the node intends to transmit on the communication medium during the shared-contention transmission opportunity. At least one of the nodes is assigned to a contention window of a plurality of contention windows within the transmission opportunity based on the transmitted priority information.

### CROSS-REFERENCE TO RELATED APPLICATIONS

This application claims priority under 35 U.S.C. §119(e)(1) to U.S. Provisional Patent Application Ser. No. 61/024,999, filed Jan. 31, 2008, entitled “Contention Access to a Communication Medium in a Communications Network”, and bearing Attorney Docket No. 1560.189.101/2007P53111US; and U.S. Provisional Patent Application Ser. No. 61/027,713, filed Feb. 11, 2008, entitled “Contention Access to a Communication Medium in a Communications Network”, and bearing Attorney Docket No. 1560.201.101/2007P53111-2US; the entire teachings of both of which are incorporated herein by reference.

### BACKGROUND

Home networking (HN) typically involves the distribution of broadband services within a customer's premises and communication between various units of customer equipment. Both wireline and wireless HN solutions are currently used. With wireline solutions, a typical HN environment contains multiple network nodes connected to a wireline medium. With wireless solutions, stations typically communicate with an access point, which is a central node of the network. The access point forwards (relays) received messages to addressed nodes.

For both wireless and wireline solutions, HN nodes typically communicate with a residential gateway (RG) for broadband services like television and voice over internet protocol (VoIP). Other HN nodes communicate data from private sources of digital content at the customer premises, such as, for example, from a digital video recorder (DVR) or a computer streaming video.

Broadband services and proprietary applications for HN systems typically have strict requirements for quality of service (QoS). A typical HN environment will also include devices that do not have any specific QoS requirements. Examples of such devices are printers, scanners, various types of home automation devices (e.g., automated heating and cooling systems), security devices (e.g., burglar alarm systems), as well as other devices. In some HN systems, devices contend for access to the communication medium, and collisions of transmitted data can occur.

### SUMMARY

One embodiment provides a method of providing contention access to a communication medium in a communications network. The method includes transmitting priority information with each of a plurality of network nodes prior to a shared-contention transmission opportunity. The priority information for each node indicates a priority level of a frame that the node intends to transmit on the communication medium during the shared-contention transmission opportunity. At least one of the nodes is assigned to a contention window of a plurality of contention windows within the transmission opportunity based on the transmitted priority information.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a diagram illustrating some example medium access control (MAC) cycles.

FIG. 2 is a diagram illustrating an example method for providing contention access with collision avoidance.

FIG. 3 is a diagram illustrating a modified version of the example method for providing contention access with collision avoidance shown in FIG. 2.

FIG. 4 is a diagram illustrating a communications network according to one embodiment.

FIG. 5 is a diagram illustrating queues for one of the nodes shown in FIG. 4 according to one embodiment.

FIG. 6 is a diagram illustrating a method for providing contention access with collision avoidance according to one embodiment.

FIG. 7 is a flow diagram illustrating a method for sharing a network communication medium according to one embodiment.

FIG. 8 is a flow diagram illustrating a method for sharing a network communication medium in a network without a master node according to one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

As mentioned above in the Background section, broadband services for home networking (HN) systems typically have strict requirements for QoS. The QoS requirements are intended to guarantee an acceptable quality of service by defining ranges of key parameters such as delay, delay variation (jitter), and bit rate. One issue that is addressed in meeting QoS requirements is collision avoidance (i.e., preventing a situation where more than one node is simultaneously transmitting data). One approach for providing collision avoidance is called synchronized media access, and is currently used in IEEE 802.11e, IEEE 1394, and other HN technologies.

With the synchronized media access approach, all of the access time is divided into medium access control (MAC) cycles. Each HN node can transmit only in a timeslot (TS) allocated to it by a master node, within the transmission opportunity (TXOP) part of a MAC cycle. The master node is responsible for assigning timeslots to nodes that request permission to transmit during the cycle, such that each node can transmit a certain amount of data without collisions. To provide nodes with the assigned time slot information, the master transmits a time marker and a media access plan (MAP). The time marker (sometimes called a “beacon”) is the time reference for all nodes in the network, while the MAP identifies the assignments of the transmission opportunities during the MAC cycle.

For network nodes that do not have strict QoS requirements, it is common to define periods that are shared among several stations to transmit data. In this case, collisions may conceivably occur (which is the reason why QoS is difficult to guarantee), but should be kept to a minimum. This can be achieved in several ways. For example, the order in which transmission opportunities can be claimed by the nodes can be predetermined by the master. The order can also be arbitrary, but the probability of collisions is reduced by randomizing the time of claim.

All of these schemes assume a carrier-sense function in the nodes, which involves detecting whether another node is transmitting. Such methods are collectively labeled “CSMA/CA” (Carrier Sense Multiple Access/Collision Avoidance). Examples of CSMA/CA are ITU-T Recommendation G.9954, IEEE 802. 11, and others. A goal of CSMA/CA is to optimize the throughput of the network by reducing the number of collisions on the one hand and increasing efficiency of medium use on the other. These goals are mutually contradictory.

A specific weakness of some CSMA/CA systems is that adaptation to excessive traffic occurs only after collisions have occurred; and if traffic continues to be heavy, each node must go again through the same process of training and increasing a contention window size (CWS) through collisions. A specific weakness of some other CSMA/CA systems is that they reduce the number of collisions by eliminating the lower-priority traffic from competition, with the drawback that a low-priority transmission may be deferred indefinitely.

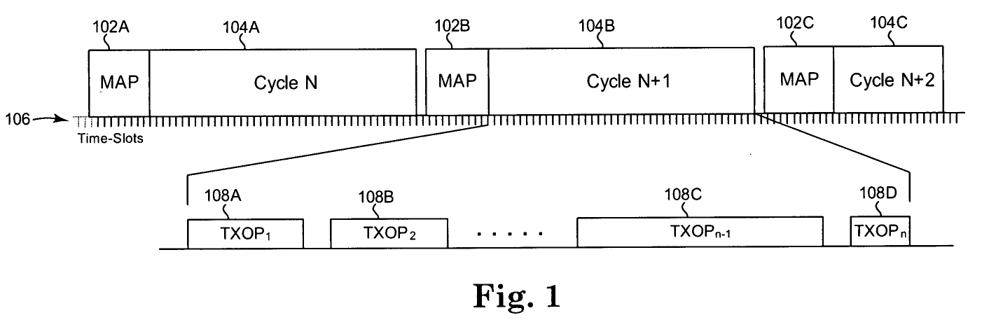

FIG. 1 is a diagram illustrating some example MAC cycles. Three consecutive MAC cycles 104A-104C (i.e., cycle N, cycle N+1, and cycle N+2) are shown in FIG. 1. At the beginning of the MAC cycles 104A-104C, a master node transmits media access plans (MAPs) 102A-102C, respectively. The MAC cycles 104A-104C and the MAPs 102A-102C are positioned on a horizontal time axis in FIG. 1 that is divided into a plurality of time slots 106.

The MAPs 102A-102C define the assignment of transmission opportunities (TXOPs) to nodes. Each of the MAC cycles 104A-104C includes multiple TXOPs. In the illustrated example, MAC cycle 104B includes TXOPs 108A-108D (i.e., TXOP₁, TXOP₂, TXOPₙ₋₁, and TXOPₙ). TXOPs can either be assigned to a particular node, as defined in the MAP, or can be a shared-contention TXOP, during which many nodes can compete for the medium.

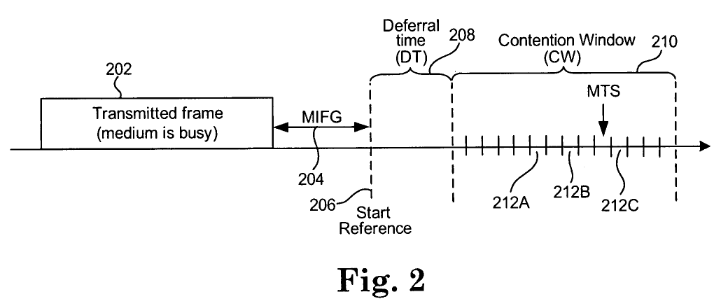

Several current HN technologies use contention access with collision avoidance. In IEEE standard 802.11, the CSMA/CA mechanism is implemented by using a random backoff in time. FIG. 2 is a diagram illustrating an example method for providing contention access with collision avoidance. With this method, network nodes first watch the medium until it becomes free (i.e., no nodes are transmitting). As shown in the example of FIG. 2, the nodes will detect that a frame 202 is being transmitted, and will wait for completion of the transmission. The nodes then wait an additional specified period of time, which is referred to as a minimum inter-frame gap (MIFG) 204. At that point, the nodes reach a start reference point 206 from which every node, autonomously, assigns a deferral time (DT) 208 and a contention window (CW) 210.

The end of the deferral time 208 marks the beginning of the contention window 210. The contention window 210 contains an integer number of micro-timeslots (MTS), such as micro-timeslots 212A-212C. The micro-timeslots are collectively referred to as micro-timeslots 212. Each node randomly picks one of the micro-timeslots 212 as the planned starting point for its transmission and starts to monitor the medium again. The selected micro-timeslot for a node is referred to herein as an access time, and is the time within the contention window at which the node will attempt to access the medium to transmit a frame. If a node detects no other node start of a transmission before its selected micro-timeslot 212, the node begins transmitting. If a node detects that another node has started transmission before its selected micro-timeslot, the node does not transmit, but waits until the medium becomes silent before continuing the process of accessing the medium.

The method described above with respect to FIG. 2 does not completely avoid collisions, but it reduces their probability because the method scatters the starting times of the different nodes competing for the medium within the contention window 210. If two nodes select different micro-timeslots 212 (e.g., a first node selects a timeslot 212A that is different than a timeslot 212B selected by a second node), there will not be a collision between those two nodes. If there are many nodes competing and the contention window 210 is small, the probability that two nodes will select the same micro-timeslot (and thus collide) is high. The size of the contention window 210 may be adjusted based on how often retransmissions are occurring (e.g., every node monitors the frequency of retransmissions and adjusts the contention window 210 accordingly). If retransmissions are too frequent, the contention window 210 may be enlarged exponentially. The above technique provides decisions to enlarge the contention window 210 based on the rate of unsuccessful communications (i.e., no prediction is used).

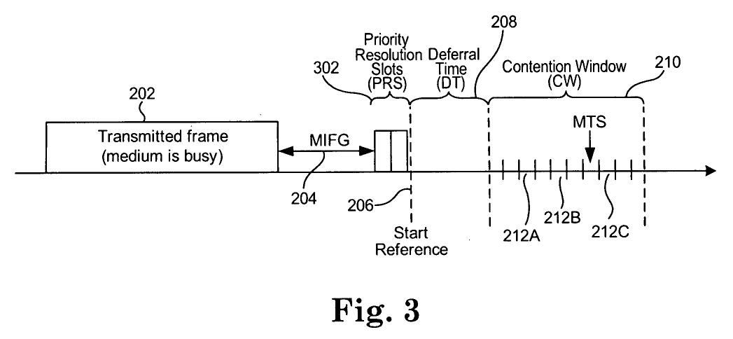

FIG. 3 is a diagram illustrating a modified version of the example method for providing contention access with collision avoidance shown in FIG. 2. As shown in FIG. 3, the network nodes again watch the medium until it becomes free (e.g., wait for the frame 202 to be transmitted), and then wait for the MIFG 204 period of time. At that point, the nodes competing for the medium provide an indication regarding the type of traffic (in terms of priority level) that each node intends to send. As shown in FIG. 3, there are timeslots, called priority resolution slots (PRS) 302, which are sent prior to the start reference point 206. During the PRS period 302, nodes competing for the medium send a short signal indicating the priority of the frame that they plan to send. All nodes monitor the PRS 302. During the PRS 302, if a node detects an advertisement of a frame that has a higher priority than the frame the node had planned to send, the node does not engage in the competition.

After the PRS 302, nodes having frames in the highest priority class choose their deferral time 208 and contention window 210, randomly pick a micro-timeslot within the contention window 210, and listen to the medium. If a node detects no other node start a transmission before its selected micro-timeslot (i.e., before its selected access time), the node begins transmitting. If a node detects that another node has started transmission before its selected micro-timeslot, the node does not transmit, but waits until the medium becomes silent before continuing the process of accessing the medium.

In the example shown in FIG. 3, only nodes having data frames with the highest priority among all the frames that have been reported engage in competing for the medium. This allows the average size of the contention window 210 to be reduced, and avoids “dead time” during which no nodes transmit. However, the size of the contention window 210 is not optimized in this example because the actual number of nodes in any priority class is unknown.

Some known solutions have rigid settings for the contention window parameter, which do not adapt to a changing mix of traffic in different priority classes. These solutions therefore provide no efficient operation. Furthermore, the adjustment of a contention window based on past performance (e.g., statistics of previous collisions) also allows only limited efficiency of operation. One embodiment addresses the fact that current CSMA/CA techniques adapt to excessive traffic only through the training of “hard knocks” (i.e., collisions). These collisions waste time and require correction at the layer-2 or higher-layer protocol level.

One embodiment improves network efficiency by optimizing medium utilization during a contention period (e.g., during a shared-contention TXOP). In one embodiment, multiple priority-based contention windows are used for each shared-contention TXOP, and the contention windows are adjusted to be long enough to reduce the probability of collisions, without excessive “dead time”, which leads to increased utilization of the medium. In one embodiment, the contention window sizes and access times are set based on the network conditions expected for an upcoming medium-access opportunity (i.e., a shared TXOP with contention access). In one embodiment, the contention windows and access times are adjusted based on various indications that are attached to transmitted information by nodes, or that are provided by the nodes in special messages and/or on special channels.

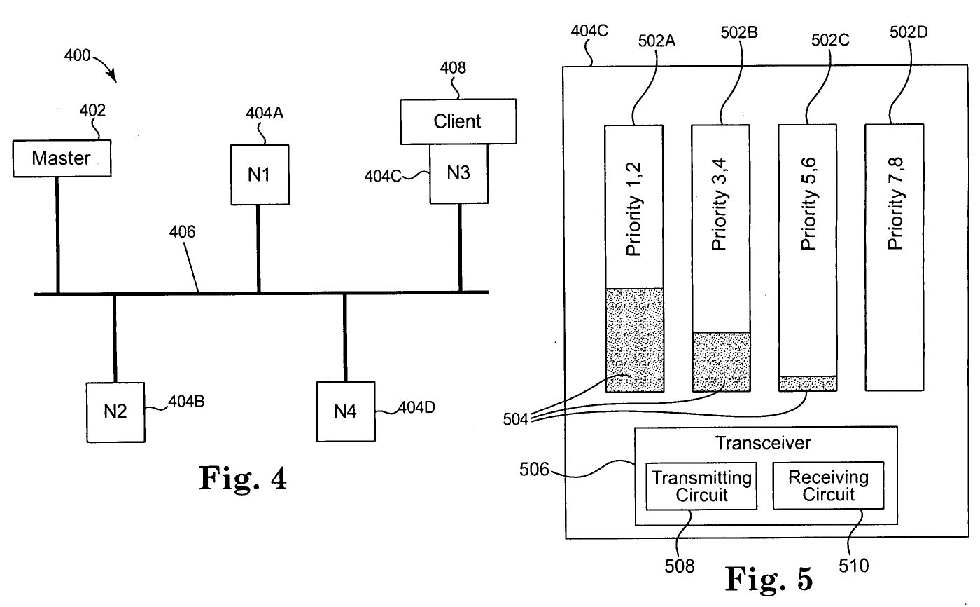

FIG. 4 is a diagram illustrating a communications network 400 according to one embodiment. Network 400 includes master node 402, network nodes 404A-404D (N1-N4), and communication medium 406. In one embodiment, communication medium 406 is a wired medium. In another embodiment, communication medium 406 is a wireless medium. In yet another embodiment, communication medium 406 includes both wired and wireless mediums. Master node 402 and network nodes 404A-404D are communicatively coupled to each other via the communication medium 406. Master node 402 operates as a network controller in one embodiment. Each node 404A-404D is configured to be supplied with data to send from one or more sources. The sources provide nodes 404A-404D with data having different priority levels. In the illustrated embodiment, client 408 is a source of data for node 404C, and provides node 404C with data having eight different priority levels. In other embodiments, more or less than eight priority levels may be used. Priority levels may, for example, be correlated to Quality of Service requirements that are assigned to the transmission data.

Nodes 404A-404D store data to be transmitted in a plurality of queues. FIG. 5 is a diagram illustrating queues 502A-502D for node 404C according to one embodiment. In the illustrated embodiment, the number of queues (i.e., four) is less than the number of priority levels (i.e., eight). Queue 502A stores frames having priority level 1 or 2, queue 502B stores frames having priority level 3 or 4, queue 502C stores frames having priority level 5 or 6, and queue 502D stores frames having priority level 7 or 8. In one embodiment, a higher number represents a higher priority level (i.e., a priority level 8 frame has a higher priority than a priority level 1 frame). If a node has frames of different priority levels ready to send, the node will send a frame with the highest priority first. Frames with lower priority are placed in an appropriate one of the queues 502A-502D for the next transmission opportunity. As shown in FIG. 5, frames 504 are stored in queues 502A-502C, and queue 502D is empty. Thus, the next frame that node 404C will attempt to transmit will be from queue 502C, because the queue 502D for the higher priorities is empty. As shown in FIG. 5, node 404C also includes a transceiver 506, which includes a transmitting circuit 508 and a receiving circuit 510. Transmitting circuit 508 is configured to transmit information, such as priority information and data frames, onto communication medium 406, and receiving circuit 510 is configured to receive information, such as priority information and data frames, from communication medium 406.

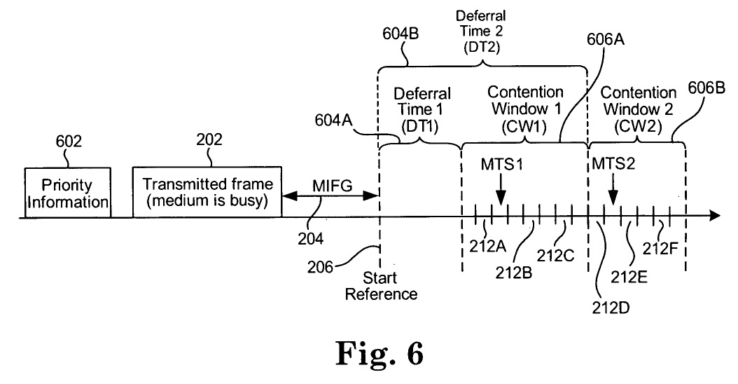

FIG. 6 is a diagram illustrating a method for providing contention access with collision avoidance performed by communications network 400 according to one embodiment. The network nodes 404A-404D (FIG. 4) each transmit priority information 602. The priority information 602 transmitted by each node indicates the priority level of a frame that the node intends to send during the next shared-contention TXOP. A plurality of deferral times 604A and 604B (collectively referred to as deferral times 604) and a plurality of contention windows 606A and 606B (collectively referred to as contention windows 606) are then determined based on the transmitted priority information 602. The contention windows 606 are priority-based contention windows that correspond to different priority levels (e.g., contention window 606A (CW1) corresponds to, for example, priority levels 5-8, and contention window 606B (CW2) corresponds to priority levels 1-4). Deferral times 604A and 604B begin at the start reference point 206 (i.e., at the end of the MIFG period 204). The end of deferral time 604A (DT1) marks the beginning of the first contention window 606A. The end of deferral time 604B (DT2) marks the beginning of the second contention window 606B. The nodes are each assigned to one of the plurality of contention windows 606 within a given shared-contention TXOP based on the transmitted priority information 602.

In the embodiment shown in FIG. 6, two contention windows 606 are used for eight different priority levels. In another embodiment, more or less than two contention windows 606 are used for each shared-contention TXOP (e.g., if the system uses eight priority levels, each shared-contention TXOP may include eight contention windows 606, with one contention window 606 for each priority level). In one embodiment, the number of contention windows 606 is varied from one shared-contention TXOP to the next based on the number of nodes intending to transmit at the various priority levels. For example, if there are no nodes that intend to transmit a frame with a priority level of 1, but the nodes intend to transmit frames with priorities 2-8, the number of contention windows 606 may be reduced from 8 to 7.

An access time may also be determined for each of the nodes 404A-404D that plans to transmit a frame during the upcoming shared-contention TXOP. In one embodiment, each of the nodes 404A-404D is configured to determine its own access time by randomly selecting a micro-timeslot within the appropriate contention window for that node using a conventional random backoff technique. FIG. 6 shows example micro-timeslots 212A-212C in contention window 606A, and example micro-timeslots 212D-212F in contention window 606B. In another embodiment, a deterministic approach is used to define an order of transmission for the nodes 404A-404D that intend to transmit a frame during the upcoming TXOP. In the embodiment shown in FIG. 6, a first micro-timeslot (MTS1) in the first contention window 606A has been selected as the access time for a first node that plans to send a frame with a priority level in the range of 5-8, and a second micro-timeslot (MTS2) in the second contention window 606B has been selected as the access time for a second node that plans to send a frame with a priority level in the range of 1-4. Likewise, other nodes that intend to transmit a frame during the upcoming TXOP will also be assigned an access time in either the first contention window 606A or the second contention window 606B, with the appropriate contention window selected for each node based upon the priority of the frame to be transmitted.

The nodes 404A-404D watch the medium until it becomes free (e.g., wait for the frame 202 to be transmitted), and then wait for the MIFG 204 and deferral time 604A. If a node assigned an access time in the first contention window 606A detects no other node start a transmission during the first contention window 606A before its selected access time, the node begins transmitting at that point. Similarly, if a node assigned an access time in the second contention window 606B detects no other node start a transmission during the second contention window 606B before its selected access time, the second node begins transmitting at that point. If a node detects that another node has started transmission within its contention window and before its selected access time, the node does not transmit, but waits until the medium becomes silent before continuing the process of accessing the medium.

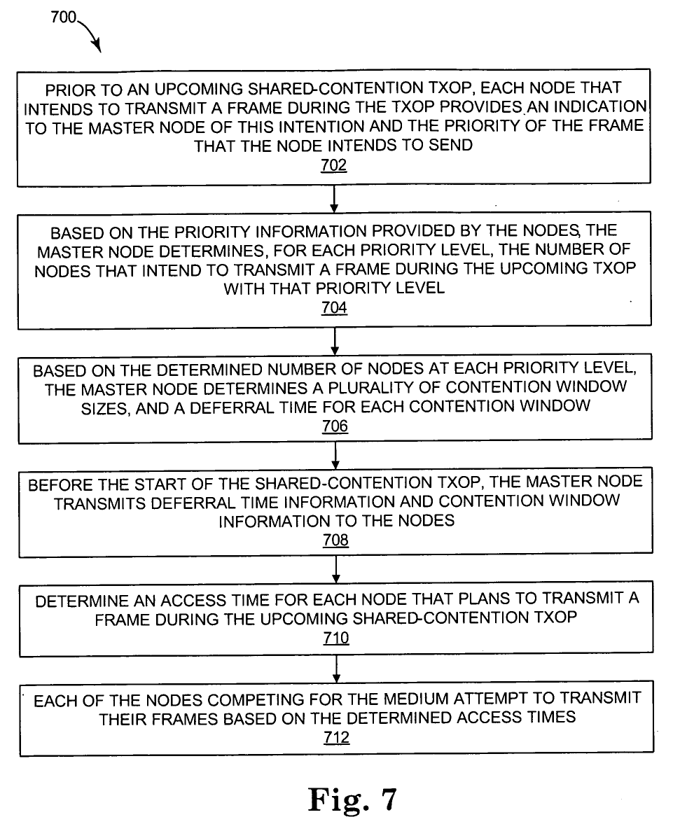

FIG. 7 is a flow diagram illustrating a method 700 for sharing a network communication medium according to one embodiment. The method 700 will be described in the context of the network 400 shown in FIG. 4. At 702 in method 700, prior to an upcoming shared-contention transmission opportunity (TXOP), each of the nodes 404A-404D that intends to transmit a frame during the TXOP provides an indication to the master node 402 of its intention to take part in the competition for the upcoming shared TXOP, and the priority of the frame that the node intends to send. In one embodiment, the nodes 404A-404D transmit priority information 602 (FIG. 6) at 702. In one embodiment, the priority information 602 provided by the nodes 404A-404D at 702 is attached to a previously transmitted data frame (i.e., a frame sent prior to the upcoming TXOP). In another embodiment, the priority information 602 is provided to the master node 402 in special messages (e.g., small frames dedicated to priority information).

At 704 in method 700, based on the priority information 602 provided by the nodes 404A-404D at 702, the master node 402 determines, for each priority level, the number of nodes 404A-404D that intend to transmit a frame during the upcoming TXOP with that priority level.

At 706, based on the determination at 704, the master node 402 determines a plurality of contention window sizes, and a deferral time for each contention window. In one embodiment, each of the contention windows determined at 706 corresponds to one of the priority levels (e.g., a first contention window for priority level 8, a second contention window for priority level 7, a third contention window for priority level 6, etc). In another embodiment, each of the contention windows determined at 706 corresponds to multiple priority levels (e.g., a first contention window for priority levels 7 and 8, a second contention window for priority levels 5 and 6, a third contention window for priority levels 3 and 4, etc.). According to one embodiment, the smaller the number of nodes that intend to transmit a frame at a given priority level, the smaller the size of the contention window corresponding to that priority level. For example, if there are no nodes that have announced frames for a specific priority, the contention window size for this priority may be set to a very low value (e.g., set to 0). Similarly, the larger the number of nodes that intend to transmit a frame at a given priority level, the larger the size of the contention window for that priority level.

In one embodiment, the contention windows are determined at 706 according to the advertised intentions of the nodes 404A-404D to have sizes of random backoff windows of the different priority classes. In one embodiment, the contention window sizes are determined at 706 by setting an upper limit to the probability of collision. This probability is given in the following Equation I:

P(N; W)=1−(1−0/W)(1−1/W)(1−2/W) . . . (1−(N−1)/W) Equation I

### Where:

P(N; W)=probability of collision;
W=contention window size; and
N=the aggregate demand for transmissions (i.e., the number of nodes 404A-404D competing within the contention window.

If the probability of collision is set to P, the solutions to Equation I, to very good approximation, also satisfy the following Equation II:

W=[N(N'1)/2+sqrt{(N(N−1)/2)̂2−(ln(1−P))*N(N−1)(2N−1)/3}]/9−2*ln(1−P) Equation II

If N numbers are chosen randomly in the range [1, W], the probability that there will be one or more collisions (coincidences) among them is given in the above Equation I. P(N; W) in Equation I is a pre-determined quantity (i.e., it is a number programmed into the node 402 and/or nodes 404A-404D that represents an acceptable probability of collision). N in Equation I is also a known quantity (i.e., the number of nodes competing within a given contention window can be determined based on the priority information 602 transmitted by the nodes). Thus, the size, W, of the contention window can be determined from Equation I using these known quantities. For a given aggregate demand, N, the probability of collision can be controlled by choosing a large-enough value of W. For example, if the acceptable probability of collision is 0.05, and the aggregate demand is N, the size, W, of the contention window is chosen in one embodiment as the smallest integer value of W such that P(N; W)<0.05. In this particular example, the values given in the following Table I apply:

TABLE I
Probability of Collision <0.05

| Aggregate | Minimum Size of |
|---|---|
| Transmission | Contention |
| Demand (N) | Window (W) |
| 1 | 1 |
| 2 | 20 |
| 3 | 60 |
| 4 | 119 |
| 5 | 197 |
| 6 | 295 |
| 7 | 412 |
| 8 | 549 |
| 9 | 705 |
| 10 | 881 |

It is noted that, for a fixed probability of collision P(N; W), W is nearly proportional to N̂2.1; and conversely, N is nearly proportional to Ŵ0.474. In one embodiment, for each priority class or priority level, the contention window size is limited by a maximum value, CWS_max, which will be specific to the priority class. An advantage of the above approach is that the re-sizing of the contention window happens before the transmissions, so collisions are prevented, rather than reacted to.

In other embodiments, other ways of deriving the contention window sizes may be used. In one embodiment, the contention window sizes determined at 706 also depend on other parameters communicated by the nodes 404A-404D, such as the amount of data that each node wants to send.

In one embodiment, the contention windows for the different priority levels are consecutive and non-overlapping in time, with no gap between adjacent contention windows. For example, if there are three active priority levels (i.e., the nodes 404A-404D intend to transmit frames at three different priority levels), there will be three consecutive contention windows in one embodiment. In such a case, if one or more of the contention window sizes are adjusted, the start times (indicated by the deferral times) of one or more of the contention windows is also adjusted so that the contention windows remain consecutive and non-overlapping. For example, if the first and the third contention window sizes remain unchanged, but the second contention window size is increased, the start time for the third contention window will be shifted to accommodate the increase in the size of the second contention window.

At 708 in method 700, the master node 402 transmits deferral time information and contention window information to the nodes 404A-404D before the start of the shared-contention TXOP. In one embodiment, the contention window information includes information regarding the sizes of the contention windows for the various priority levels, as well as a deferral time for each of the contention windows.

At 710, an access time is determined for each of the nodes 404A-404D that plans to transmit a frame during the upcoming shared-contention TXOP. In one embodiment, the master node 402 determines an access time for each of the nodes 404A-404D, and transmits the determined access times to the nodes 404A-404D. In another embodiment, each of the nodes 404A-404D is configured to determine its own access time at 710 by randomly selecting a micro-timeslot 212 within the appropriate contention window for that node using a conventional random backoff technique.

In another embodiment, instead of using a random backoff inside of a contention window, an order of transmission is assigned to the nodes 404A-404D at 710 in a deterministic manner. This has the advantage of optimizing utilization of the medium by eliminating dead time, which is the time between the beginning of a contention window and the moment when the winning node starts to transmit. With this approach, the dead time in the contention window can be reduced to zero. In one form of this embodiment, a virtualized random backoff technique is used. With the virtualized random backoff technique, the order in which the nodes 404A-404D will seize the medium is predicted by the master node 402, and the master node 402 communicates the determined order of transmission to the other nodes 404A-404D. For example, rather than having the nodes 404A-404D generate their own random numbers and have an actual competition for the medium, the master node 402 can have a virtual competition or simulated competition by determining the numbers that the nodes 404A-404D would have or might have come up with if there were an actual competition between the nodes 404A-404D. The master node 402 then determines the order of transmission from this virtual competition, and transmits the order to the nodes 404A-404D. In other embodiments, other approaches may be used to determine the order of transmission. In one embodiment, the method 700 uses an ordering algorithm that uses the information communicated by the nodes at 702 to determine an order of transmission.

At 712 in method 700, each of the nodes 404A-404D competing for the medium attempt to transmit their data frames based on the access times determined at 710. For an embodiment that uses a random backoff technique for selecting access times, if a node detects no other node start a transmission before its selected micro-timeslot in its contention window, the node begins transmitting. If a node detects that another node has started transmission before its selected micro-timeslot in its contention window, it does not transmit, but waits until the medium becomes silent before continuing the process of accessing the medium. For an embodiment that uses a deterministic approach for selecting access times, the nodes 404A-404D seize the medium in the order determined by the master node 402 by detecting when the medium becomes “silent” after the previous node (in the predetermined order of transmission) has completed its transmission. If the current shared-contention TXOP allows another transmission of a complete frame to take place, the node will begin transmitting its frame.

In one embodiment, method 700 is used by network 400 to adapt the contention windows 606 and deferral times 604 based on the conditions in the network 400 prior to each shared-contention TXOP. In another embodiment, the contention windows 606 and deferral times 604 are adapted in a network without a master node 402 based on the conditions in the network prior to each shared-contention TXOP. In one form of this embodiment, the nodes 404A-404D are each configured to use the same rules to separately determine the contention windows 606 and deferral times 604, and/or an order of transmission, based on the conditions in the network prior to each shared-contention TXOP.

In one embodiment, the contention window size is adjusted in accordance with an algorithm known to each node, and based upon information provided in the priority information period 602 by the individual nodes. In another embodiment, a master node sets the contention window sizes for all nodes; and the master node bases its adjustment relying upon information provided in the priority information period 602 by the individual nodes, or upon observation of the traffic patterns on the network, or upon collisions, or upon information or instruction from upper layers of software or protocol, or upon any combination of the preceding.

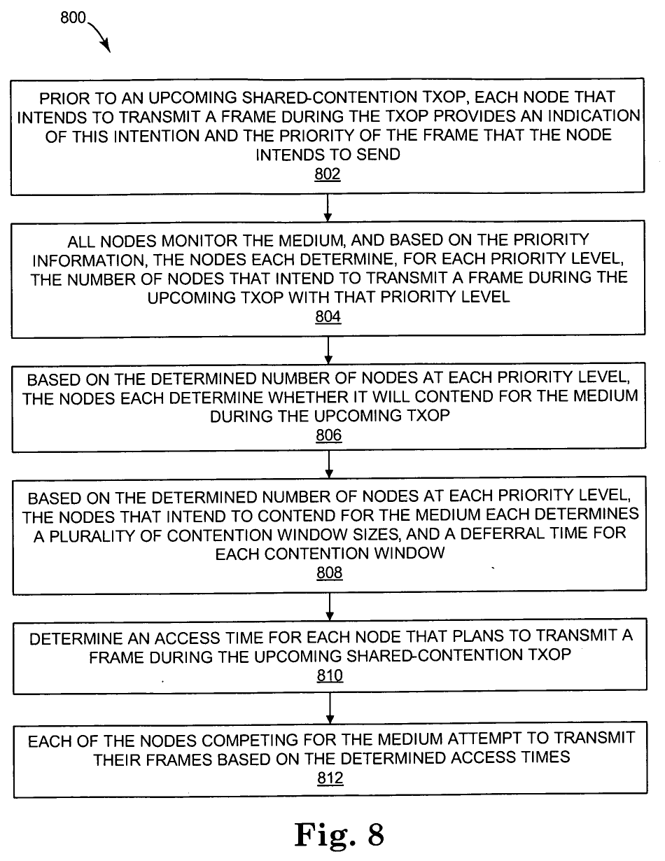

FIG. 8 is a flow diagram illustrating a method 800 for sharing a network communication medium in a network without a master node according to one embodiment. At 802 in method 800, prior to an upcoming shared-contention transmission opportunity (TXOP), each of the nodes 404A-404D that intends to transmit a frame during the TXOP provides an indication of its intention to take part in the competition for the upcoming shared TXOP, and the priority of the frame that the node intends to send. In one embodiment, the nodes 404A-404D transmit priority information 602 (FIG. 6) at 802. In one embodiment, the priority information 602 provided by the nodes 404A-404D at 802 is attached to a previously transmitted data frame (i.e., a frame sent prior to the upcoming TXOP). In another embodiment, the priority information 602 is provided by the nodes 404A-404D in special messages (e.g., small frames dedicated to priority information).

At 804 in method 800, all of the nodes 404A-404D monitor the medium and, based on the information provided at 802, the nodes 404A-404D each determine, for each priority level, the number of nodes that intend to transmit a frame during the upcoming TXOP with that priority level.

At 806, based on the determination at 804, the nodes 404A-404D each determines whether it will contend for the medium during the upcoming TXOP. In one embodiment, the nodes 404A-404D are configured to determine at 806 that they will not compete for the medium when the number of nodes that intend to send frames of higher priority than itself exceeds a predetermined limit.

At 808, based on the determination at 804, the nodes 404A-404D that intend to contend for the medium (determined at 806) each determines a plurality of contention window sizes, and a deferral time for each contention window. Thus, in one form of this embodiment, each node computes its own contention window sizes and deferral times according to the number of expected competitors and their frame priorities. The contention window sizes according to one embodiment are calculated using one of the techniques described above with respect to FIG. 7.

At 810, an access time is determined for each of the nodes 404A-404D that plans to transmit a frame during the upcoming shared-contention TXOP. In one embodiment, each of the nodes 404A-404D is configured to determine an access time for itself at 810, as well as access times for the other nodes. In one embodiment, each of the nodes 404A-404D is configured to determine its own access time at 810 by randomly selecting a micro-timeslot within the appropriate contention window for that node using a conventional random backoff technique. In another embodiment, instead of using a random backoff inside of a contention window, the order of transmission is determined by the nodes 404A-404D at 810 in a deterministic manner. In one form of this embodiment, the order of transmission is determined based on identification (ID) numbers of the nodes (e.g., the node with the lowest ID is first in the order, the node with the next lowest ID is the second in the order, etc.). In another embodiment, a random reordering function, which is known to all of the nodes 404A-404D in the network, is used. In one form of this embodiment, in each MAC cycle or otherwise periodically, the random reordering function assigns the order of transmission of all nodes in that cycle. In one embodiment, the reordering function is based upon permutation to provide for a “fair access” to any node. The reordering function is performed by each node 404A-404D in the network in one embodiment, thereby accomplishing management without a master node 402.

At 812 in method 800, each of the nodes 404A-404D competing for the medium attempt to transmit their data frames based on the access times determined at 810. For an embodiment that uses a random backoff technique for selecting access times, if a node detects no other node start a transmission before its selected micro-timeslot in its contention window, the node begins transmitting. If a node detects that another node has started transmission before its selected micro-timeslot in its contention window, it does not transmit, but waits until the medium becomes silent before continuing the process of accessing the medium. For an embodiment that uses a deterministic approach for selecting transmission times, the nodes 404A-404D seize the medium in the order determined by the nodes by detecting when the medium becomes “silent” after the previous node (in the predetermined order of transmission) has completed its transmission. If the current shared-contention TXOP allows another transmission of a complete frame to take place, the node will begin transmitting its frame.

According to one embodiment, in a case where nodes do not broadcast their sending requests on the network, the absence of any information on the number of nodes that intend to contend for the medium is replaced in one embodiment by a distributed deterministic algorithm that predetermines the order of transmission, and the use of priority slots. In the absence of information about the need of the different nodes to take part in the contention for the medium, the algorithm to determine the order of transmission applies to all nodes in one embodiment. The predetermined order applies then to the order of the priority slots, which are used by the nodes to actually detect whether a station that is allocated a slot that precedes its own actually used its transmission opportunity or not.

Unlike the node-specific contention windows used in IEEE 802.11, one embodiment uses a common contention window framework, in which contention windows have definite opening and closing times that are observed by all the nodes. In one embodiment, a dedicated priority period is allocated for announcements, by all nodes, of intent to transmit. All nodes are thus informed as to the aggregate demand for transmissions in each priority level. By a rule known to all nodes, the size of the contention window is set in accordance with the aggregate demand in one embodiment.

One embodiment allows lower-priority traffic, as well as higher-priority traffic, to compete. Different priority classes and corresponding contention windows are used, and as discussed above, the size of each contention window is determined based on the aggregate demand for that window. Lower-priority transmissions are not automatically deferred to another MAC cycle in one embodiment. Instead, after the nodes in the highest-priority contention window have had their transmissions, the nodes in the lower-priority contention windows continue to count down towards their access times. In this way, all nodes should get a chance to transmit during a MAC cycle. The exception is that when the total of all the contention window sizes exceeds a pre-determined maximum value, CWS_sum_max, the lower-priority contention window sizes are reduced or even eliminated for that MAC cycle. The rules for “abbreviating” the contention windows are known to all the nodes in one embodiment, so the nodes will follow them without external direction.

If the contention window size for a given priority class is to be shortened, it may be necessary to reduce the number of allowed transmissions to keep the probability of collision small. The allowable number of transmissions is the value, N_max, corresponding to the maximum contention window size value, CWS_max, for the agreed-upon probability of collision in Equation I (e.g., such that P(N_max; CWS_max)<0.05). In order to achieve this value, each node cuts back individually on its own number of intended transmissions. In one embodiment, each node reduces its number of transmissions for that collision window by the ratio of N_max to the aggregate number of originally planned transmissions in that collision window, and selects that number of access times within the window [1, CWS_max]. In another embodiment, each node selects its originally planned number of transmissions in the original, overly large contention window, the size of which (CWS_large) was set by the unreduced aggregate number of transmissions; but the integers representing the access times would subsequently each be reduced by the factor (CWS_max/CWS_large)̂0.474. An advantage of this approach is that the lower-priority traffic is less likely to be stalled indefinitely, even while the urgency of the higher-priority traffic is respected.

One embodiment allows more than one transmission per node per MAC cycle. During the priority information period 602 (FIG. 6), each node indicates how many frames are intended to be sent of each priority class. All nodes are thus informed of the aggregate demand for each priority class, and can thus calculate the correct contention window size for each priority class. Each node selects its announced number of random numbers within each contention window, so that it has as many opportunities to transmit within that contention window as it has frames to transmit. The calculation of the correct contention window size may be more complex than indicated in Equation I above, as the probability of collision is different when three nodes each want to send two frames than when two nodes each want to send three frames.

In any event, if the aggregate demand for a contention window is so large that the corresponding contention window size is larger than a set maximum value, CWS_max, the contention window can be shortened to the size CWS_max; and the next contention window opens up.

Another way to prevent a contention window from becoming too large is as follows: If the aggregate demand for a contention window is too large, each signaling node is allowed to send one frame in that priority class. If the calculated contention window size is less than CWS_max, each signaling node can have one more frame to transmit, and so on; if CWS_max is not large enough to allow each signaling node one more frame, each node selects a random number according to a known algorithm that gives the right number of nodes permission for an extra frame. An advantage of this approach is that it allows control over how much transmission time is given to higher-priority versus lower-priority traffic. Higher-priority traffic is given more time (when needed), but lower-priority traffic is guaranteed to have some time, except in the most extreme cases. Flexible control over the proportion of time allocated to different priority classes is exercised by adjusting the window-size parameters.

One embodiment addresses the time during which the nodes are waiting for their access times to arrive, as their timers count down. During this time, the medium is not being used. As long as the nodes do not know what the other nodes are doing, this time is sacrificed. In one embodiment, the access times selected by each node are determined by: i) the number of frames the node intends to send in each priority class; and ii) the node's random-number generating algorithms. Each such algorithm is actually deterministic. The apparent randomness of the numbers generated is due to the fact that the sequence of selected numbers is very sensitive to the initial state (the “seed”) of the random-number generator. There is no reason to keep the initial state of any node secret. The seeds are selected in one embodiment such that the sequence of numbers generated have the general characteristics of being “fairly distributed”.

In one embodiment, each node has an internal model of the set of nodes of the entire network. Since any decisions made on shortening collision windows or determining which nodes will get the extra frames are based on rules known to all the nodes, each node can predict perfectly all the selected access times based on the priority information 602 (e.g., the intended number of transmissions in each priority class). Given this knowledge of the access times, it is no longer necessary to actually wait out the contention interval from one access time to the next one. Each node will know which is the node with the earliest access time, which is the next, and so on. If two nodes end up with an identical access time (a “virtual collision”), both nodes will drop that time and reduce the number of frames to send by one. In other embodiments, other strategies may be used.

Based upon this knowledge, once one node has finished its transmission and the medium has gone idle, the following node can start the next transmission right away, without wasting any more time. In one embodiment, the access-times selected by the quasi-random processes are only used to determine the order in which the nodes will transmit, not the actual time of transmission. An advantage of this approach is that even more dead-time is squeezed out of the MAC cycle.

While a specific structure or use of transmission opportunity has been described, it is to be understood that transmission opportunity is a general term that may also encompass other time periods provided for a plurality of transmitters for transmission data.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of providing contention access to a communication medium in a communications network, comprising:
transmitting priority information with each of a plurality of network nodes prior to a shared-contention transmission opportunity, the priority information for each node indicating a priority level of a frame that the node intends to transmit on the communication medium during the shared-contention transmission opportunity; and
assigning at least one of the nodes to a contention window of a plurality of contention windows within the transmission opportunity based on the transmitted priority information.

2. The method of claim 1, wherein the contention windows are consecutive and non-overlapping in time, and wherein each of the contention windows corresponds to at least one priority level.

3. The method of claim 1, and further comprising:
determining a size for each of the plurality of contention windows based on the transmitted priority information.

4. The method of claim 1, wherein each of the nodes is configured to determine a size for each of the contention windows based on the transmitted priority information.

5. The method of claim 1, and further comprising:
determining a size for each of the contention windows with a master node based on the transmitted priority information; and
transmitting the determined sizes from the master node to the plurality of network nodes.

6. The method of claim 1, and further comprising:
determining an access time for each of the network nodes, the access time for each node indicating a time within the contention window assigned to the node that the node will attempt to access the communication medium to transmit a frame.

7. The method of claim 6, wherein each network node is configured to determine the access time for that network node.

8. The method of claim 6, wherein the access time for each network node is determined by a master node, and wherein the method further comprises:
transmitting the determined access times from the master node to the plurality of network nodes.

9. The method of claim 1, and further comprising:
determining an order of transmission based on the transmitted priority information, the order of transmission indicating an order in which the network nodes will attempt to access the communication medium for transmitting frames.

10. The method of claim 9, wherein each of the nodes is configured to determine the order of transmission.

11. The method of claim 9, wherein the order of transmission is determined by a master node, and wherein the method further comprises:
transmitting the determined order of transmission from the master node to the plurality of network nodes.

12. The method of claim 1, wherein each of the nodes is assigned to a contention window of the plurality of contention windows.

13. A communications network, comprising:
a plurality of nodes each configured to transmit priority information on a communication medium of the network prior to a shared-contention transmission opportunity, the priority information for each node indicating a priority level of a frame that the node intends to transmit during the shared-contention transmission opportunity; and
wherein each of the nodes is configured to attempt to transmit a frame within a selected one of a plurality of contention windows within the transmission opportunity, the selected contention window for each node determined based on the transmitted priority information.

14. The communications network of claim 13, wherein the contention windows are consecutive and non-overlapping in time, and wherein each of the contention windows corresponds to at least one priority level.

15. The communications network of claim 13, wherein each of the nodes is configured to determine a size for each of the contention windows based on the transmitted priority information.

16. The communications network of claim 13, and further comprising a master node configured to determine a size for each of the contention windows based on the transmitted priority information, and transmit the determined sizes to the plurality of network nodes.

17. The communications network of claim 13, wherein each network node is configured to determine an access time for that network node, the access time for each node indicating a time within the contention window selected for the node that the node will attempt to access the communication medium to transmit a frame.

18. The communications network of claim 13, and further comprising a master node configured to determine an access time for each network node, the access time for each node indicating a time within the contention window selected for the node that the node will attempt to access the communication medium to transmit a frame, and wherein the master node is configured to transmit the determined access times to the plurality of network nodes.

19. The communications network of claim 13, wherein each of the network nodes is configured to determine an order of transmission based on the transmitted priority information, the order of transmission indicating an order in which the network nodes will attempt to access the communication medium for transmitting frames.

20. The communications network of claim 13, and further comprising a master node configured to determine an order of transmission based on the transmitted priority information, the order of transmission indicating an order in which the network nodes will attempt to access the communication medium for transmitting frames, and wherein the master node is configured to transmit the determined order of transmission to the plurality of network nodes.

21. A method of providing a shared-contention transmission opportunity in a communications network, comprising:
transmitting priority information onto a communication medium of the network with each of a plurality of network nodes prior to the shared-contention transmission opportunity, the priority information for each node indicating a priority level of a frame that the node intends to transmit during the shared-contention transmission opportunity;
providing a plurality of priority-based contention windows within the transmission opportunity; and
determining a size for each of the contention windows based on the transmitted priority information.

22. A transceiver comprising:
a transmitting circuit configured to transmit priority information on a communication medium of a network prior to a shared-contention transmission opportunity, the priority information indicating a priority level of a frame that the transceiver intends to transmit during the shared-contention transmission opportunity; and
wherein the transceiver is configured to attempt to transmit a frame within a selected one of a plurality of contention windows within the transmission opportunity, the selected contention window determined based on transmitted priority information.
